(19) United States
(12) Patent Application Publication
(10) Pub. No.: US 2023/0365112 A1
(43) Pub. Date: Nov. 16, 2023

(54) Brake actuator for a vehicle including a cylinder and dust plug

(71) Applicant: ZF Commercial Vehicle Control Systems India Limited, Chennai (IN)

(72) Inventors: Senthil Kumar Arangarasan, Chennai (IN); Arunkumar Mani, Karur (IN); Venkata Sruthi Bommu, Anantapur (IN); Ramakrishna Avvaru, Chennai (IN); Ramesh Puyalraj, Chennai (IN)

(21) Appl. No.: 18/315,071

(22) Filed: May 10, 2023

(30) Foreign Application Priority Data
May 10, 2022 (IN) 202241027019

(51) Int. Cl. B60T 17/08

(52) U.S. Cl. CPC B60T 17/083; B60T 17/085

(57) ABSTRACT

A brake actuator for a vehicle includes a cylinder housing having a surface and a wall opening provided in this surface, a brake chamber having a variable volume and a dust plug releasably arranged in the wall opening. The dust plug includes a flexible circumferential lip configured for abutting against the surface of the cylinder housing in a sealing state, and for being flexed away from the surface in a flexed state. The lip is configured to assume the flexed state in response to a positive pressure inside the brake chamber, and to assume the sealing state in response to negative pressure inside the brake chamber. A core section is arranged adjacent to the lip and the core section is configured for extending through the wall opening of the cylinder housing. A pressure compensation flow path is defined between the lip and the brake chamber.

### CROSS-REFERENCE TO RELATED APPLICATIONS

This application claims priority of Indian patent application no. 202241027019, filed May 10, 2022, the entire content of which is incorporated herein by reference.

### TECHNICAL FIELD

The disclosure relates to a brake actuator for a vehicle, the brake actuator including a cylinder housing having a surface and a wall opening provided in the surface, a brake chamber having a variable volume, a dust plug being releasably arranged in the wall opening, the dust plug including a flexible circumferential lip configured for abutting against the surface of the cylinder housing in a sealing state, and for being flexed away from the surface in a flexed state, wherein the lip is configured to assume the flexed state in response to a positive pressure inside the brake chamber, and to assume the sealing state in response to negative pressure inside the brake chamber, and a core section being arranged adjacent to the lip, wherein the core section is configured for extending through the wall opening of the cylinder housing, a pressure compensation flow path that is defined between the lip and the brake chamber.

### BACKGROUND

Brake actuators, in particular parking or emergency brake actuators, of the aforementioned type are generally known in the art. As such, they may be configured as spring brake actuators including a parking brake portion and a spring brake portion, as well as an electro-mechanical actuator. Typically, the actuators include a cylinder housing including a wall opening for inserting a so-called release bolt. Such a release bolt is utilized to manually disengage the parking brake portion of the actuator. During normal vehicle operation, the release bolt is removed from the wall opening. To prevent dust or water from entering the actuator, the wall opening is closed with a dust plug.

When the parking brake is released, a pressure larger than the ambient pressure builds up in the spring chamber that needs to evade from the housing. In order to achieve this, known dust plugs include a slot arranged in the periphery of the dust plug through which the overpressure may evade from the brake chamber. The evading pressure flexes the lip from the cylinder housing. In other words, a gap is created between the lip and the cylinder housing, when pressure is evaded, which may allow dust or water enter the brake chamber. This is highly unwanted.

### SUMMARY

In view thereof, it is an object of the disclosure to improve the brake actuator of the initially mentioned type to overcome the deficiencies found in the prior art as much as possible. In particular, it was an object of the disclosure to provide an improved brake actuator which is less susceptible to dust and water entry into the brake chamber and which is easy to install and manufacture.

The disclosure attains the aforementioned objects by providing a brake actuator of the initially mentioned type, wherein the core section includes a circumferential baffle wall, the flow path includes a passage opening extending from the surface through the cylinder housing and the pressure compensation flow path has a first flow path section extending from the lip to the passage opening and a second flow path section extending from the passage opening along the baffle wall,
the second flow path section being arranged at an angle relative to the first flow path section, preferably orthogonally, such that matter entering the flow path from the outside of the cylinder housing is deflected by the baffle wall away from the brake chamber.

The disclosure is based upon the realization that instead of providing a flow path through the dust plug, by guiding the flow path through the cylinder housing and by deflecting the flow by means of the baffle wall, the probability is highly reduced that dust or water unwantedly enter the brake chamber. In particular when the actuator is mounted horizontally, water and dust may enter the passage opening but will be guided with the help of the flow path out of the brake actuator without entering the brake chamber.

The dust plug, the surface and the wall opening are preferably dimensioned such that matter entering the flow path from the outside of the cylinder housing is deflected by the baffle wall away from the brake chamber. Preferably, the lip is configured to sealingly close the pressure compensation flow path when in the sealing state, and to open the pressure compensation flow path when in the flexed state. In other words, the combination of cylinder and dust plug works as a check valve.

According to an embodiment, the passage opening is formed at an outside diameter of the wall opening. In this way, a well-defined flow path is defined directly adjacent to the dust plug.

According to yet another embodiment, the passage opening is a first passage opening and the spring brake actuator includes a second passage opening arranged at the outside diameter of the wall opening, wherein the second opening is arranged opposite from the first opening, such that the flow diverted by the baffle wall is guided towards a second passage opening.

Thereby, a flow of water or dust that enters the cylinder housing via, for example, the first passage opening, is deflected by the baffle wall and thereafter guided along the baffle wall towards the second passage opening, at which the dust or water may exit the cylinder housing again. In this way, the probability of water or dust entering the brake chamber is further minimized.

In another embodiment, the passage opening is arranged spaced apart from the wall opening. In other words, the passage opening forms a separate opening with respect to the wall opening. While providing the same benefits with regard to the entry of dust or water, such a configuration may be easier to assemble or to retrofit.

According to yet another embodiment, the passage opening is a first passage opening and the spring brake actuator includes a second passage opening arranged spaced apart from the outside diameter of the wall opening, wherein the first opening is arranged opposite from the second opening, such that the flow diverted by the baffle wall is guided towards the second passage opening.

With this configuration, again, entering dust or water is guided through the first opening via the baffle wall towards the second compensation opening and thereafter out of the housing.

According to yet another embodiment, the passage openings are arranged on a diameter coaxial to the longitudinal axis of the cylinder housing. In this way, the flow characteristics through and out of the compensation openings are unified.

According to yet another embodiment, the at least one passage opening includes, at least partially, a circular outer cross section. This cross section has been found to be beneficial to allow for a convenient pressure compensation, while at the same time, the probability of dust or water entering the cylinder housing is minimized. In case however dust or water enter the housing, the configuration facilitates the water or dust exiting the housing via the passage openings.

According to yet another embodiment, the core section includes at least one circumferential bead for providing an interference fit with the wall opening of the cylinder housing. The bead not only provides an interference fit with the wall opening but is also beneficial in guiding water or dust that have unwantedly entered the cylinder housing out of the housing again. Preferably, the bead is part of the baffle wall.

According to another embodiment, the core section includes a flexible flange section being arranged adjacent to the core section, the flange section including a diameter larger than a diameter of the core section for providing a snap fit connection with the cylinder housing. The flange allows for a convenient assembly and disassembly of the dust plug. Furthermore, the flange portion of the dust plug may also facilitate guiding dust or water through the housing and away from the brake chamber.

According to yet another embodiment, the dust plug includes a reinforcement structure for improving the structural rigidity of the dust plug. According to yet another embodiment, the reinforcement structure includes two stiffening elements, the two stiffening elements forming a cross-shaped structure. The reinforcement structure helps preventing the dust plug from being dislocated when air passes along the dust plug. Furthermore, the reinforcement structure allows for a more compact configuration of the dust plug.

In a further aspect, the disclosure relates to a dust plug for insertion into in a wall opening of a cylinder housing of a spring brake actuator, the dust plug including: a flexible circumferential lip covering a compensation flow path fluidly connecting a brake chamber with an outside of the actuator, the lip configured for abutting against a section of the cylinder housing, wherein the lip is deflected from the cylinder housing when pressure from the brake chamber exhausts through the pressure compensation flow path, and a core section being arranged adjacent to the lip, wherein the core section is configured for engaging with the wall opening of the cylinder housing, wherein the core section includes a baffle wall.

According to an embodiment, the core section includes at least one circumferential bead for providing an interference fit with the wall opening of the cylinder housing.

According to yet another embodiment, the core section includes a flexible flange section being arranged adjacent to the core section, the flange section including a diameter larger than a diameter of the core section for providing a snap fit connection with the cylinder housing. Preferably, the dust plug includes a reinforcement structure for improving the structural rigidity of the dust plug.

The dust plug takes advantage of the same benefits and embodiments as the spring brake actuator according to the disclosure and vice versa. In this regard and in order to avoid unnecessary repetitions, reference is made to the above explanations.

### BRIEF DESCRIPTION OF DRAWINGS

The invention will now be described with reference to the drawings wherein:

FIG. 1 shows a schematic cross-sectional view of a spring brake actuator according to an embodiment;

FIG. 2 shows a dimensional view of a cylinder housing of the spring brake actuator according to the embodiment;

FIGS. 3 to 5 show an embodiment of a dust plug according to the disclosure;

FIGS. 6 to 8 show the spring brake actuator according to the embodiment in different views;

FIGS. 9 and 10 show the spring brake actuator according to the disclosure including an alternative cylinder housing embodiment; and,

FIG. 11 shows the alternative embodiment of the cylinder housing according to FIGS. 9 and 10 in a perspective view.

### DETAILED DESCRIPTION

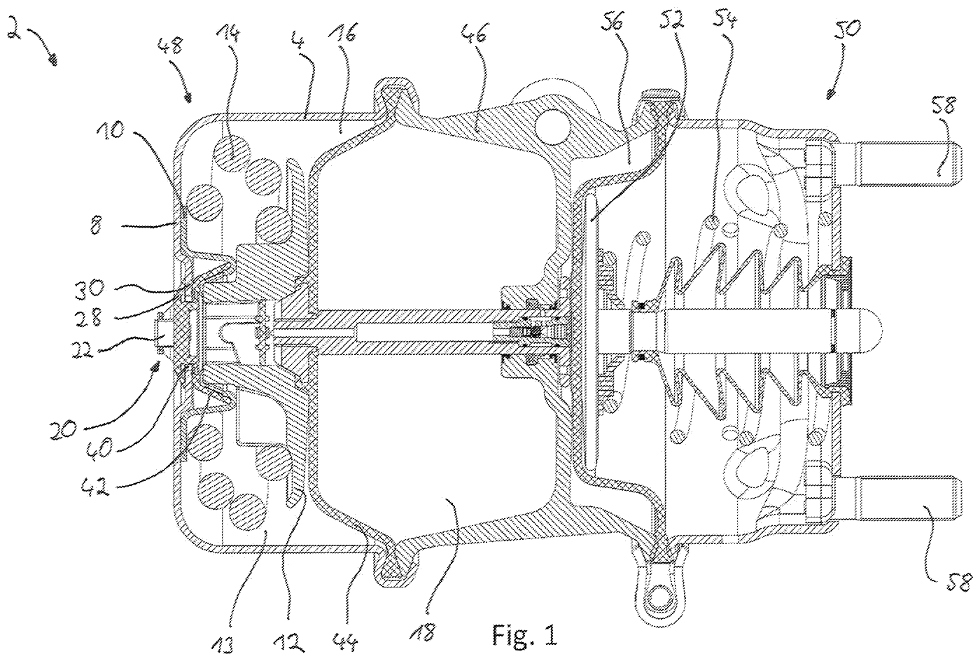

FIG. 1 shows a spring brake actuator 2 for use in a commercial vehicle. The spring brake actuator 2 includes a spring brake portion 48 and a service brake portion 50. The spring brake portion 48 includes a cylinder housing 4. The cylinder housing 4 includes a cylinder housing base 8 and a spring seat 10 on the base 8.

The spring brake 48 furthermore includes a spring brake piston 12 located in the cylinder housing 4 for applying a braking force and a compression spring 14 arranged between the spring seat 10 and the spring brake piston 12, the compression spring 14 being effective to push the spring brake piston 12 away from the cylinder housing base 8.

The cylinder housing 4 is divided into a brake chamber/spring chamber 16 and a pressure chamber 18. The compression spring 14 is arranged in the spring chamber 16. The pressure chamber 18 is supplied with pressurized fluid. The spring chamber 16 is separated from the pressure chamber 18 by a diaphragm 44. The cylinder housing 4 is attached to a housing section 46 which may have the form of a flange.

The brake actuator 2 furthermore includes a passage opening 40 which is arranged in the cylinder housing 4. The cylinder housing 4 moreover includes a wall opening 20. The wall opening 20 is configured for accommodating a release bolt (not shown). During normal operation, a dust plug 22 is releasably arranged in the wall opening 20. The dust plug 22 includes a flexible circumferential lip 28. The flexible circumferential lip 28 covers the passage opening 40. The lip 28 is configured for abutting against a section 30 of the cylinder housing 4 that includes the passage opening 40. The lip 28 gets deflected from the cylinder housing 4 when pressure evades from the spring chamber 16 through the passage opening 40. Moreover, a sealing element 42 is arranged between the spring seat 10 and the cylinder housing 4.

The service brake section 50 includes a service brake piston 52 which is moved against the force of a service brake compression spring 54 by pressure inside the service brake chamber 56. The spring brake actuator 2 may be attached to the vehicle by means of mounting bolts 58.

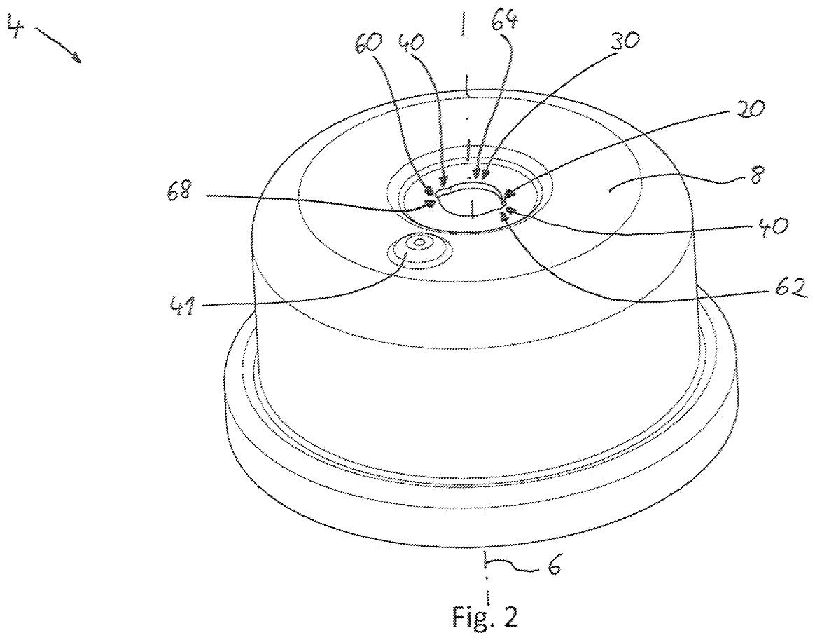

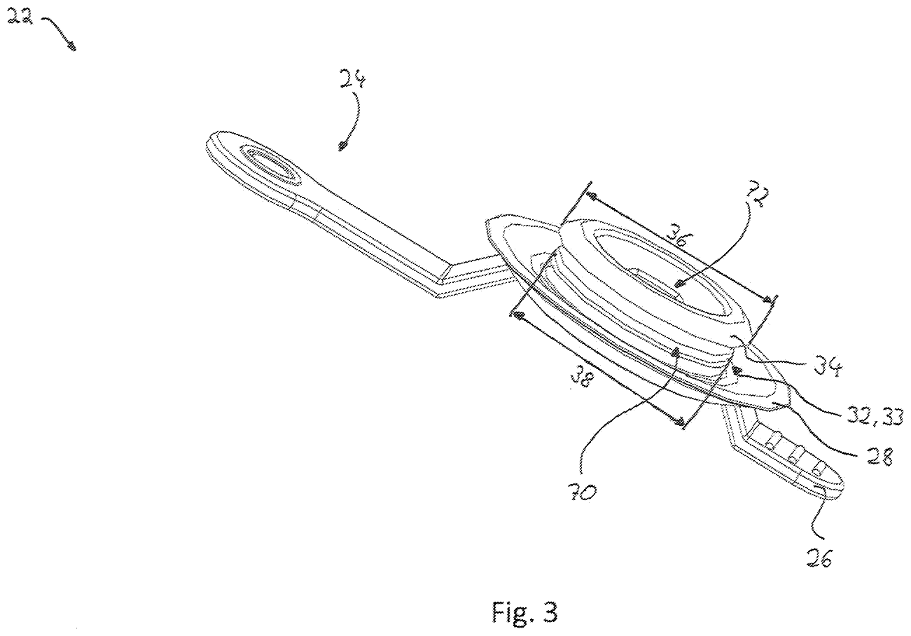

FIG. 2 shows a perspective view of the cylinder housing 4. The cylinder housing 4 includes the wall opening 20. The wall opening 20 is aligned with a longitudinal axis 6. The wall opening 20 is arranged at the cylinder housing base 8. The cylinder housing 4 includes two passage openings 40. The passage openings 40 are formed at an outside diameter 64 of the wall opening 40. The passage openings 40 include a first passage opening 60 and a second passage opening 62. The first passage opening 60 is arranged opposite from the second passage opening 62. The passage openings 40, 60, 62 are arranged on a diameter coaxial to the longitudinal axis 6 of the cylinder housing 4 that is covered by the lip 28. The passage openings 40, 60, 62 partially include a circular outer cross section 68. The cylinder housing 4 moreover includes an attachment section 41 for attaching a dust plug mounting section 24 (see FIG. 3).

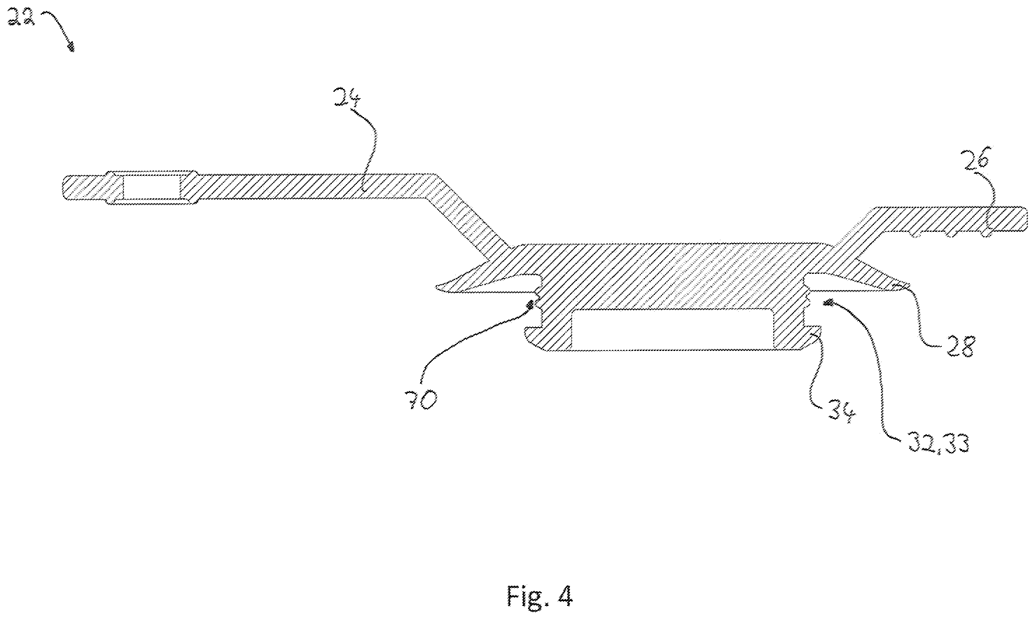

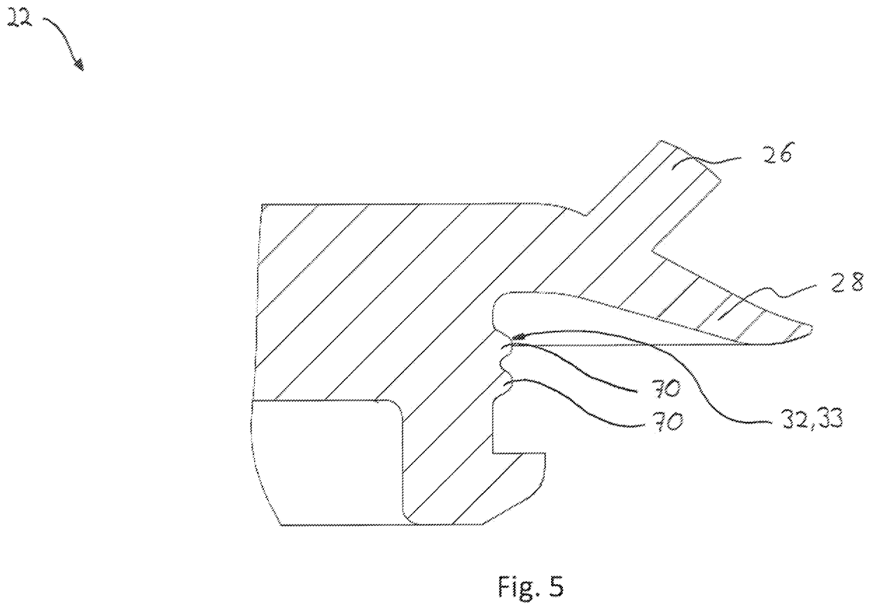

FIGS. 3 to 5 show the dust plug 22. The dust plug 22 includes the flexible circumferential lip 28 towards which a dust plug mounting section 24 and a dust plug actuating section 26 is attached. The dust plug 22 furthermore includes a core section 32. The core section 32 is arranged adjacent to the lip 28. The core section 32 is configured for engaging with the wall opening 20 of the cylinder housing 4. The core section 32 includes a baffle wall 33. The core section 32 furthermore includes a circumferential bead 70. The circumferential bead 70 is configured for providing an interference fit with a wall opening 20 of the cylinder housing 4. The core section 32 furthermore includes a flexible flange section 34. The flexible flange section 34 is arranged adjacent to the core section 32. The flange section 34 includes a diameter 36 being larger than a diameter 38 of the core section 32 in order to provide a snap-fit connection with the cylinder housing 4. Furthermore, the dust plug 22 includes a reinforcement structure 72 for improving the structural rigidity of the dust plug 22.

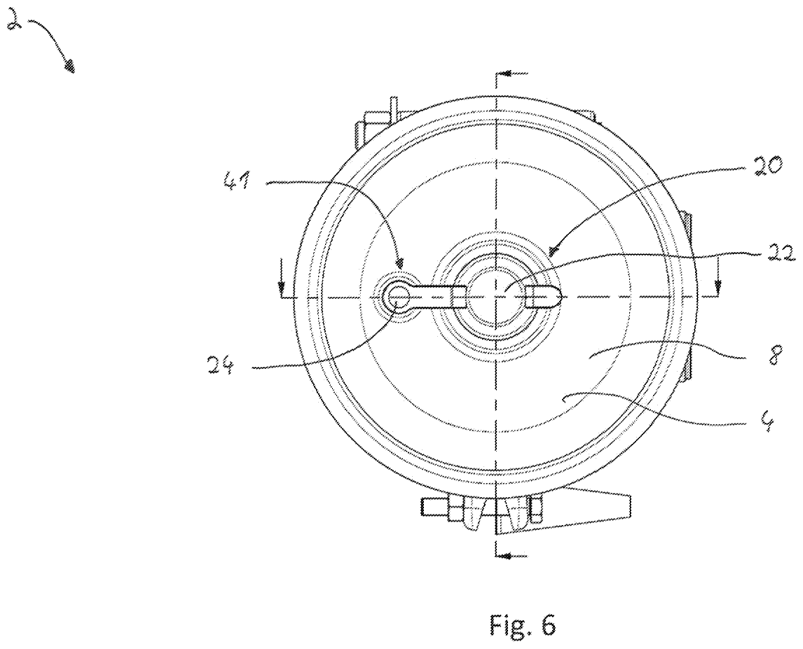

FIG. 6 shows the spring brake actuator 2 in a side view. At the cylinder housing base 8 of the cylinder housing 4, the dust plug 22 is arranged in the wall opening 20. The dust plug mounting section 24 of the dust plug 22 is mounted to the cylinder housing 4 by means of the attachment section 41.

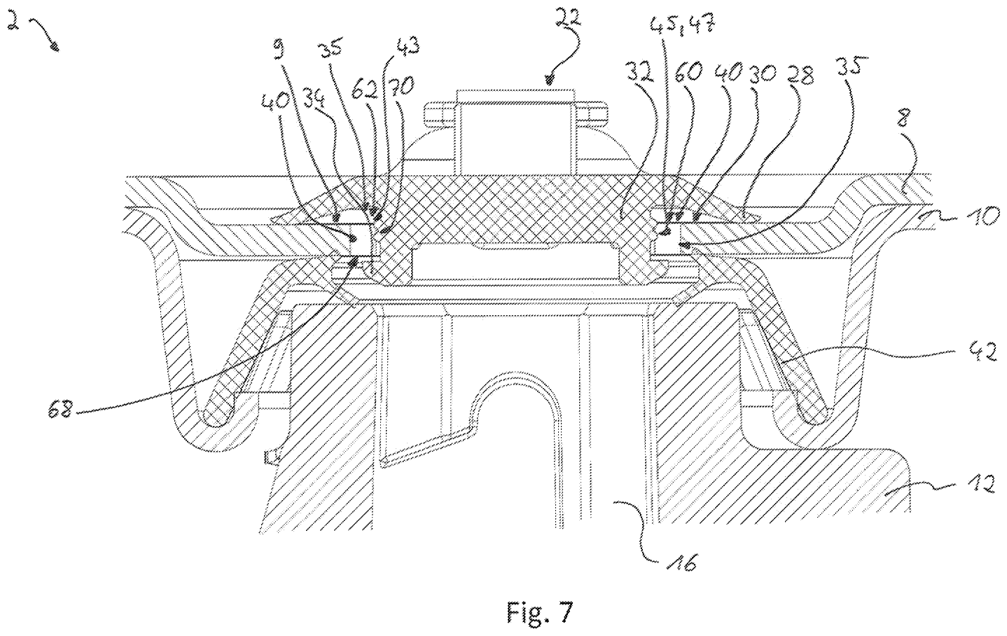

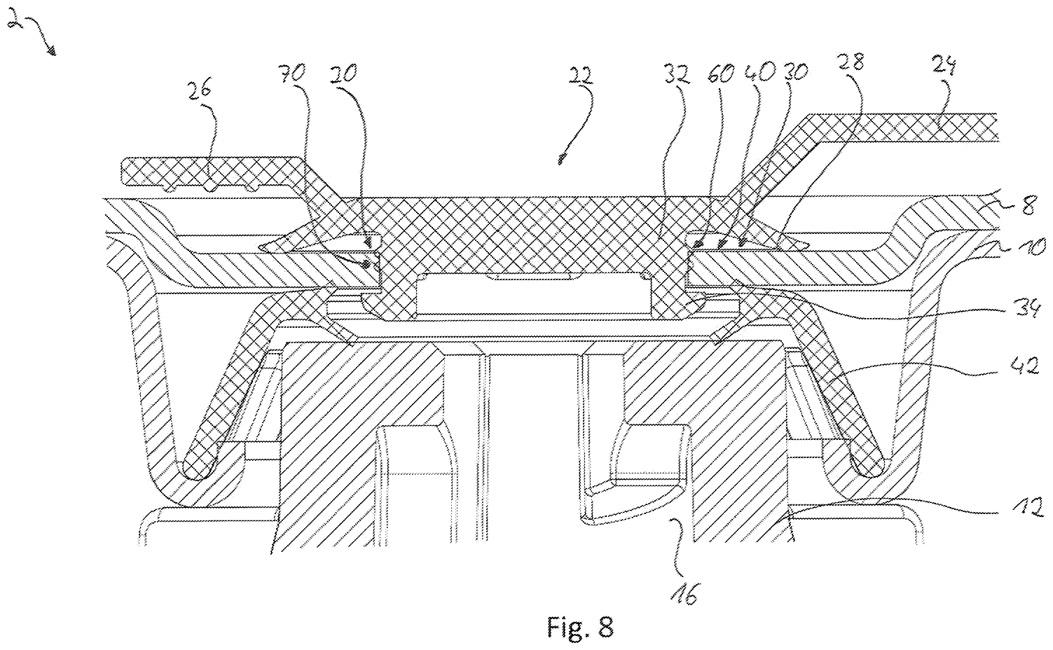

FIGS. 7 and 8 show cross-sectional views of a detail of the spring brake actuator 2. As already pointed out, the core section 32 includes a baffle wall 33. The passage opening 40 and the baffle wall 33 delimit a flow path 35 through the cylinder housing 4. The baffle wall 33 is configured for deflecting a flow through the flow path 35 such that a flow entering the flow path 35 from the outside of the cylinder housing 4 passing the flexible circumferential lip 28 and the passage opening 40 is deflected by the baffle wall 33 away from the brake chamber 16. For example, when water or dust enters the cylinder housing 4 via the first compensation opening 60, the flow including the water or dust is diverted by the baffle wall 33 and guided towards the second passage opening 62 and vice versa. In this way, the flow may exit the cylinder housing 4 through the second passage opening 62 and the flexible circumferential lip 28. In this way, dust or water is prevented from entering the brake chamber or spring chamber 16. In the perspective of FIG. 8, the snap-fit and interference fit between the dust plug 22 and the cylinder housing base 8 is shown. The core section 32 having the circumferential bead 70 provides an interference fit with the wall opening 20. Moreover, the flexible flange section 34 provides a snap-fit connection with the cylinder housing 4.

In other words, the flexible circumferential lip 28 is configured for abutting against the surface 9 of the cylinder housing 4 in a sealing state, and for being flexed away from the surface 9 in a flexed state. The lip 28 is configured to assume the flexed state in response to deflected from the cylinder housing 4 when a positive pressure from inside the brake chamber 16 exhausts through the pressure compensation flow path 40, and to assume the sealing state in response to negative pressure inside the brake chamber 16. A core section 32 is arranged adjacent to the lip 28. The core section 32 is configured for engaging extending through with the wall opening 20 of the cylinder housing 4. A pressure compensation flow path 35 is defined between the lip 28 and the brake chamber 16.

The core section 32 includes a circumferential baffle wall 33. The flow path 35 includes a passage opening 40 extending from the surface 9 through the cylinder housing 4 and the pressure compensation opening flow path 35 has a first flow path section 43 extending from the lip 28 to the passage opening 40 and the radial baffle wall 33 delimiting and a second flow path section 45 extending from the passage opening 40 along the baffle wall 33.

The second flow path 35 section is arranged at an angle 47 relative to the first flow path section 43, preferably orthogonally, such that matter entering the flow path 35 from the outside of the cylinder housing 4 is deflected by the baffle wall 33 away from the brake chamber 16.

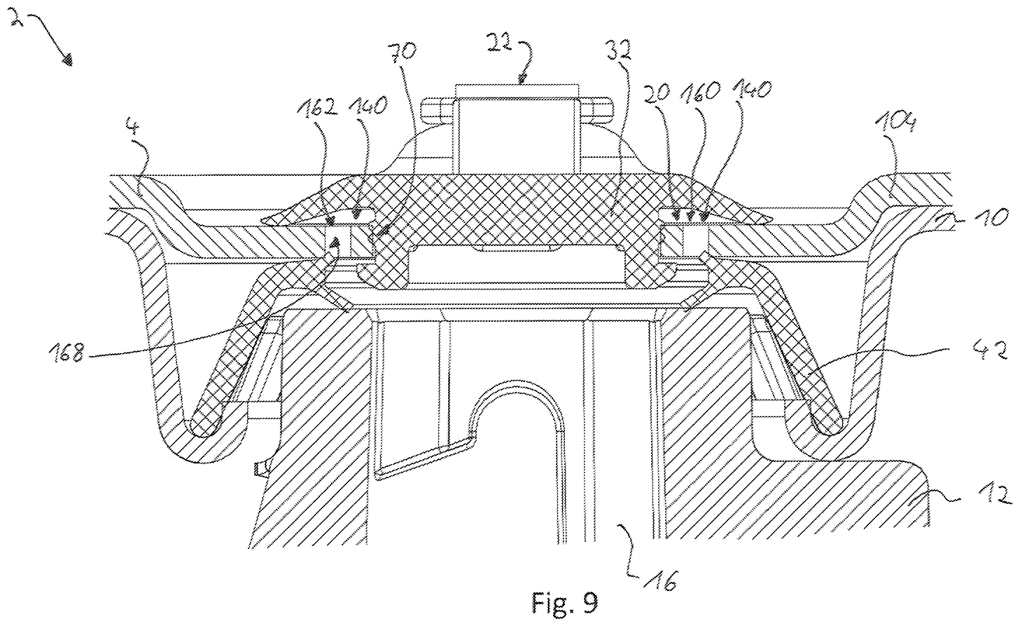

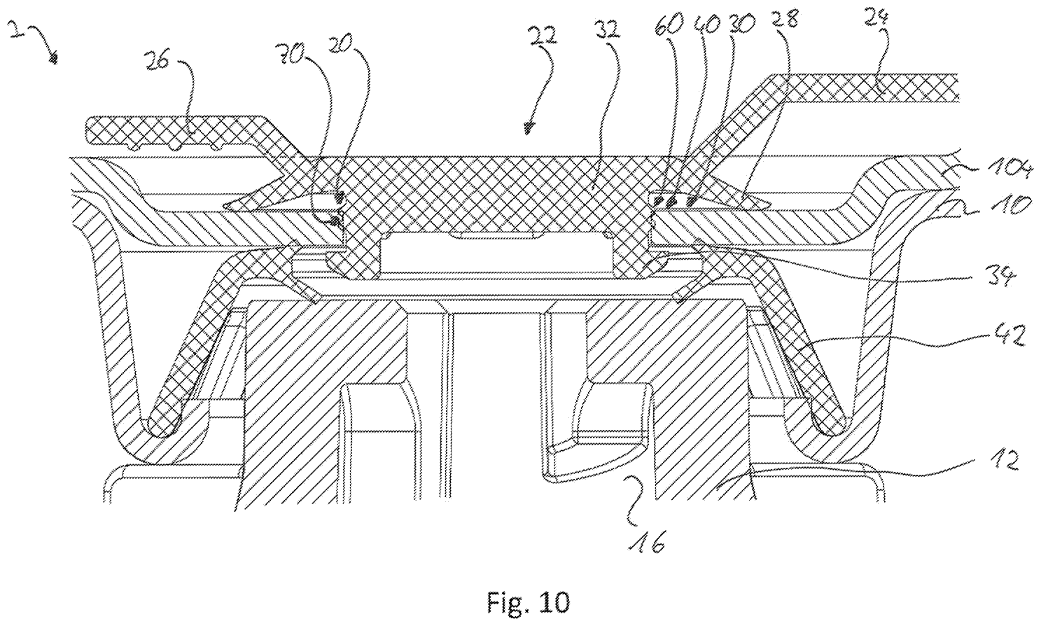

FIGS. 9 and 10 show the spring brake actuator 2 which is, except from the cylinder housing 104, similar to the embodiment shown in FIGS. 7 and 8. In the embodiment of FIGS. 9 and 10, passage openings 140 are arranged spaced apart from a wall opening 120. The passage openings 140 are arranged in a surface 109 and are configured as a first passage opening 160 and a second passage opening 162. The first passage opening 160 is arranged spaced apart from an outside diameter 164 of the wall opening 120 and are covered by the lip 28. The first opening 160 is arranged opposite from the second opening 162, such that a flow diverted by the baffle wall 33 is guided towards the second passage opening 162 and vice versa. The passage openings 160, 162 are arranged on a diameter coaxial to a longitudinal axis 106 of the cylinder housing 104. The passage openings 140, 160, 162 include a circular outer cross section 168.

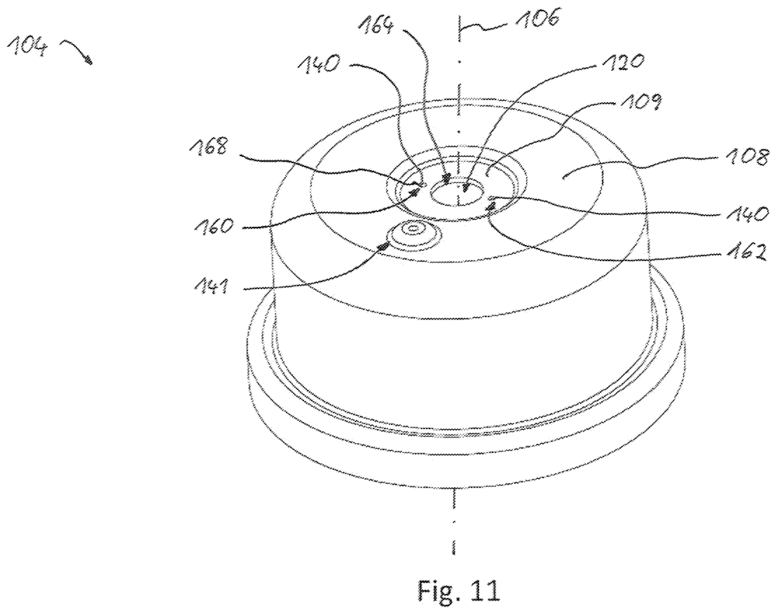

FIG. 11 shows a perspective view of the cylinder housing 104. The cylinder housing 104 includes the wall opening 120. The wall opening 120 is aligned with a longitudinal axis 106. The wall opening 120 is arranged at the cylinder housing base 108. The surface 109 of the cylinder housing 104 includes two passage openings 140. The passage openings 140 are arranged spaced apart from a wall opening 120. The passage openings 140 are configured as a first passage opening 160 and a second passage opening 162. The first opening 160 is arranged opposite from the second opening 162. The passage openings 160, 162 are arranged on a diameter coaxial to the longitudinal axis 106 of the cylinder housing 104. The passage openings 140, 160, 162 include a circular outer cross section 168. The cylinder housing 104 moreover includes an attachment section 141 for attaching a dust plug mounting section 24 (see FIG. 3).

It is understood that the foregoing description is that of the preferred embodiments of the invention and that various changes and modifications may be made thereto without departing from the spirit and scope of the invention as defined in the appended claims.

### LIST OF REFERENCES

2 spring brake actuator
4 cylinder housing
6 longitudinal axis
8 cylinder housing base
9 surface
10 spring seat
12 spring brake piston
13 variable volume
14 compression spring
16 brake chamber/spring chamber
18 pressure chamber
20 wall opening
22 dust plug
24 dust plug mounting section
26 dust plug actuating section
28 flexible circumferential lip
30 section of the cylinder housing
32 core section
33 baffle wall
34 flexible flange section
35 pressure compensation flow path
36 flange section diameter
38 core section diameter
40 passage opening
41 attachment section
42 sealing element
43 first flow path section
44 diaphragm
45 second flow path section
46 housing section
47 angle
48 spring brake
50 service brake
52 service brake piston
54 service brake compression spring
56 service brake chamber
58 mounting bolts
60 first passage opening
62 second passage opening
64 outside diameter of the opening
68 circular outer cross section
70 circumferential bead
72 reinforcement structure
104 cylinder housing
106 longitudinal axis
108 cylinder housing base
109 surface
120 wall opening
140 passage opening
141 attachment section
160 first passage opening
162 second passage opening
164 outside diameter
168 circular outer cross section

1. A brake actuator for a vehicle including a commercial vehicle, the brake actuator comprising:
a cylinder housing having a surface and a wall opening provided in said surface;
a brake chamber having a variable volume;
a dust plug releasably arranged in said wall opening;
said dust plug including:
a flexible circumferential lip configured for abutting against said surface of said cylinder housing in a sealing state, and for being flexed away from said surface in a flexed state;
said flexible circumferential lip being configured to assume said flexed state in response to a positive pressure inside said brake chamber and to assume said sealing state in response to negative pressure inside said brake chamber;
a core section being arranged adjacent to said flexible circumferential lip and being configured for extending through said wall opening of said cylinder housing;
a pressure compensation flow path defined between said flexible circumferential lip and said brake chamber;
said core section including a circumferential baffle wall;
said pressure compensation flow path including a passage opening extending from said surface through said cylinder housing and having a first flow path section extending from said flexible circumferential lip to said passage opening and a second flow path section extending from said passage opening along said baffle wall; and,
said second flow path section being arranged at an angle relative to said first flow path section.

2. The brake actuator of claim 1, wherein said passage opening is formed at an outside diameter of said passage opening.

3. The brake actuator of claim 2, wherein said passage opening is a first passage opening and said brake actuator includes a second passage opening arranged at said outside diameter of said wall opening; and, said second passage opening is arranged opposite from said first passage opening, such that the flow diverted by said baffle wall is guided toward said second passage opening.

4. The brake actuator of claim 1, wherein said passage opening is arranged spaced apart from said wall opening.

5. The brake actuator of claim 4, wherein said passage opening is a first passage opening and the brake actuator further comprises a second passage opening arranged spaced apart from said outside diameter of said wall opening; and, said first passage opening is arranged opposite from said second passage opening, such that the flow diverted by said baffle wall is guided toward said second passage opening.

6. The brake actuator of claim 3, wherein said passage openings are arranged on a diameter coaxial to a longitudinal axis of said cylinder housing.

7. The brake actuator of claim 3, wherein at least one of said passage openings comprises, at least partially, a circular outer cross section.

8. The brake actuator of claim 1, wherein said core section comprises at least one circumferential bead for providing an interference fit with said wall opening of said cylinder housing.

9. The brake actuator of claim 1, wherein said core section includes a flexible flange section arranged adjacent to said core section; and, said flange section has a diameter larger than a diameter of said core section for providing a snap fit connection with said cylinder housing.

10. The brake actuator of claim 1, wherein said dust plug includes a reinforcement structure for improving the structural rigidity of said dust plug.

11. A dust plug for insertion into a wall opening of a cylinder housing of a spring brake actuator having a brake chamber, said dust plug comprising:
a flexible circumferential lip configured for abutting against a surface of said cylinder housing in a sealing state, and for being flexed away from said surface in a flexed state;
said flexible circumferential lip being configured to assume said flexed state in response to being deflected from said cylinder housing when a positive pressure from inside said brake chamber exhausts through a pressure compensation flow path, and to assume the sealing state in response to negative pressure inside the brake chamber;
a core section arranged adjacent to said flexible circumferential lip, said core section being configured for engaging and extending through a wall opening of the cylinder housing; and,
said core section including a circumferential baffle wall.

12. The dust plug of claim 11, wherein said core section includes at least one circumferential bead for providing an interference fit with said wall opening of said cylinder housing.

13. The dust plug of claim 11, wherein said core section includes a flexible flange section arranged adjacent to said core section; and, said flange section includes a diameter larger than a diameter of said core section for providing a snap fit connection with said cylinder housing.

14. The dust plug of claim 11, wherein said dust plug further comprises a reinforcement structure for improving the structural rigidity of said dust plug.

15. The brake actuator of claim 1, wherein said brake actuator is a spring brake actuator.

16. The brake actuator of claim 1, wherein said second flow path section is arranged orthogonally relative to said first flow path section.
